(19) United States
(12) Patent Application Publication
(10) Pub. No.: US 2006/0028720 A1
(43) Pub. Date: Feb. 9, 2006

(54) Telescope system and method

(76) Inventor: David Harrelson, Alpharetta, GA (US)

Correspondence Address: SCOTT M LOHNES, 11400 BROOKHOLLOW TRAIL, ALPHARETTA, GA, 30022, US

(21) Appl. No.: 10/911,256

(22) Filed: Aug. 4, 2004

(51) Int. Cl. G02B 23/00

(52) U.S. Cl. 359/399; 359/400; 250/203.1

(57) ABSTRACT

A system and method for viewing and tracking astronomical objects using a telescope located on a balcony or deck-like structure. A telescope system comprising a portable computer controlled telescope, a video imaging camera attached to the telescope, and a monitor connected to the video camera. The telescope with the video camera attached is precisely balanced in both altitude and azimuth. A method for viewing and tracking astronomical objects with a telescope system comprising the following steps: providing a telescope system comprising a portable computer controlled telescope, a video imaging camera attached to the telescope, and a monitor; precisely balancing the telescope with the camera attached in both altitude and azimuth for the telescope's entire range of motion; placing the telescope and camera on a structure that allows movement in relation to the earth's surface; and performing an alignment of the telescope.

### TECHNICAL FIELD

The present invention is generally related to telescope systems and, more particularly, is related to a system and method for a telescope system for using on a balcony or deck-like structure.

### BACKGROUND OF THE INVENTION

Telescopes for observing and/or photographing celestial objects such as planets, moons, stars, galaxies, asteroids, comets, nebulae, and the like are well known. Such telescopes range in size from small, readily portable ones to large fixed ones which are permanently located in observatories. The smaller telescopes are commonly used by students, hobbyists, and amateur astronomers. The larger telescopes are generally only used by researchers and professional astronomers.

The smaller telescopes are portable to allow the amateur astronomer to take the telescope to a location that permits a good view of the night sky and is away from light pollution caused by urban lights. These telescopes are used with very stable tripods or other holders with a solid base on the ground.

People in urban areas have been unable to participate in the area of astronomy because of the brightness of the night sky. These people must pack up their telescope equipment and go to a remote area where the night sky is not obscured by light pollution.

Furthermore, the most convenient place for some people, especially apartment dwellers, to observe the night sky is a deck attached to their house or apartment. However, telescope manufacturers do not recommend the positioning of a telescope on such a structure because the structure shifts with the movement of the bodies on the structure. Such shifting would cause the view of the telescope to move and make the alignment of the telescope difficult. All astronomy literature and experts in astronomy tell you that the telescope must be firmly mounted to solid ground.

Another difficulty with the study of astronomy is that the person must be outside in the elements with his telescope while making the observations. As the observations are made at night and during all times of year, the environment may be cold, hot, humid, dewy, insect/animal infested, or other undesirable conditions. These elements affect the comfort and/or safety of persons and may then reduce the amount of time the amateur astronomer spends making observations of the night sky.

Thus, a heretofore unaddressed need exists in the field of astronomy to address the aforementioned deficiencies and inadequacies.

### SUMMARY OF THE INVENTION

Embodiments of the present invention provide a system and method for viewing and tracking astronomical objects using a telescope located on a balcony or deck-like structure.

Briefly described, in architecture, one embodiment of the system, among others, can be implemented as follows. A telescope system comprising a portable computer controlled telescope, a video imaging camera attached to the telescope, and a monitor connected to the video camera. The telescope with the video camera attached is precisely balanced in both altitude and azimuth.

Embodiments of the present invention can also be viewed as providing methods for viewing and tracking astronomical objects with a telescope system. In this regard, one embodiment of such a method, among others, can be broadly summarized by the following steps: providing a telescope system comprising a portable computer controlled telescope, a video imaging camera attached to the telescope, and a monitor; precisely balancing the telescope with the camera attached in both altitude and azimuth for the telescope's entire range of motion; placing the telescope and camera on a structure that allows movement in relation to the earth's surface; and performing an alignment of the telescope.

Other systems, methods, features, and advantages of the present invention will be or become apparent to one with skill in the art upon examination of the following drawings and detailed description. It is intended that all such additional systems, methods, features, and advantages be included within this description, be within the scope of the present invention, and be protected by the accompanying claims.

### BRIEF DESCRIPTION OF THE DRAWINGS

Many aspects of the invention can be better understood with reference to the following drawings. The components in the drawings are not necessarily to scale, emphasis instead being placed upon clearly illustrating the principles of the present invention. Moreover, in the drawings, like reference numerals designate corresponding parts throughout the several views.

FIG. 1 is a block diagram of a telescope system according to one embodiment of the present invention.

FIG. 2 is a front view of a monitor for the telescope system of FIG. 1.

FIG. 3 is a flow chart of a method of telescope viewing and tracking according to another embodiment of the present invention.

### DETAILED DESCRIPTION OF THE PREFERRED EMBODIMENT

The telescope tracking system and method of the present invention permits people to pursue their interest in astronomy even if they reside in an urban location, with their telescope located on a balcony or deck-like structure, and while they are located in the comfort of their home or apartment. The telescope tracking system includes a computer controlled telescope, an astronomy video imaging camera, and a monitor.

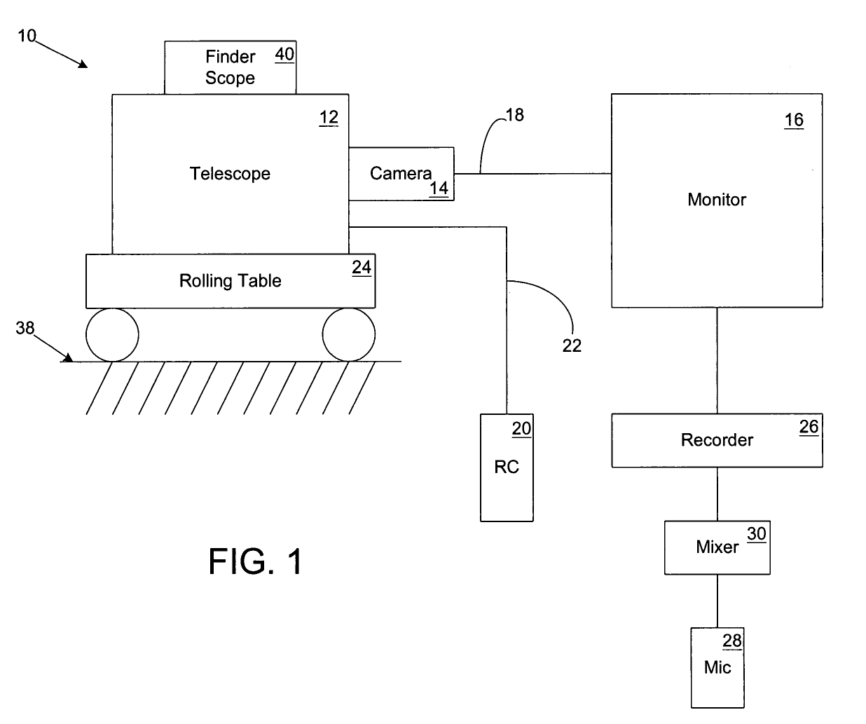

Referring to FIG. 1, a first embodiment of the present invention is shown. The telescope tracking system 10 includes a computer controlled telescope 12, a video imaging camera 14 attached to the telescope 12, and a monitor 16 connected to camera 14 via a cable 18. A remote control 20 for controlling the movement of the telescope is connected to the telescope 15 via a cable 22. A finder scope 40 is attached to the telescope 12 to facilitate the initial alignment of the telescope 12. The telescope 12 may also be mounted on a rolling table 24 to facilitate the movement of the telescope 12 to and from balcony or deck-like structure 38.

A recorder 26 may also be connected to an output of the monitor 16 to record the output of the of the camera 14. The recorder 26 may be of the type to record on DVD's, video tapes, or other storage mediums. A microphone 28 and power mixer 30 may also be connected to the recorder 26 to enable the user to add audio to the storage medium.

The computer controlled telescope 12, such as a Meade LX200GPS, after an alignment automatically moves the telescope in both altitude and azimuth to compensate for the movement of the earth in relation to the sky. Other astronomical objects in the sky can be located by the user by merely selecting the next object for the telescope to locate. The telescope 12 with the camera 14 attached must be precisely balanced in both altitude and azimuth throughout its entire range of motion, such that when moved to a specific position, it will remain in that position until moved to another position. It may be necessary to add additional balancing weights to most, if not all, standard telescopes to achieve this precise balance.

A precisely balanced telescope will not cause any shifting of weight to its mounting device (for example, the rolling table) which, in turn, does not cause any shifting in the deck or balcony on which the telescope is located. Shifting of the deck may not allow the telescope to align properly and changes the view through the telescope, because even a small shift will translate into a large shift when viewing very distant objects. When a telescope is positioned on solid ground, such balancing is not necessary because the ground will not shift due the shifting weight of the telescope. Smaller telescopes, such as the Meade ETX-70AT, may not require to be precisely balanced since the amount of weight shifted throughout the range of motion of the telescope is very small.

The video imaging camera 14, such as an Astrovid StellaCam EX, transmits the image from the telescope 12 via cable 22 to the monitor 16, preferably a high resolution monitor. The Astrovid StellaCam EX uses charged-coupled device (CCD) technology and accumulates and averages data for approximately two seconds between downloads. This type of camera allows the viewing of deep space objects, such as star clusters, nebulae, and galaxies. Cameras with lesser light sensitivity can be used to observe objects in our solar system, such as the sun, moon, planets, comets, and asteroids.

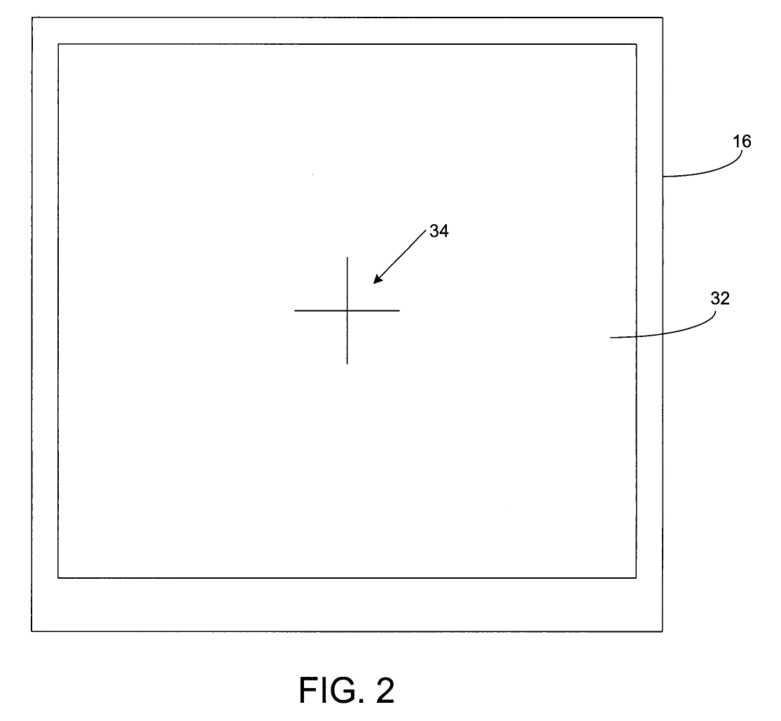

The monitor 16 includes a screen 32 and a set of cross hairs 34 (FIG. 2) in the center of the screen 32. The set of cross hairs 34 facilitate the centering of alignment stars on the monitor 16 during alignment of the telescope 12. The set of cross hairs 34 may be grease pencil marks on the screen 32 or another device that provides a set of cross hairs over the screen 32.

The rolling table 24 allows the user to easily move the telescope 12 onto a deck or other location outside of his house or apartment. Cables 18 and 22 are of suitable length to permit the monitor 16 to be located inside the house or apartment and to allow the user to operate the telescope 12 via the remote control 20 while viewing the monitor 16. These cables could be as short as ten feet long or extend over hundreds of feet. The typical cable provided from the manufacturer running from the telescope 12 to the remote control 20 is only long enough to use in the general area of the telescope 12.

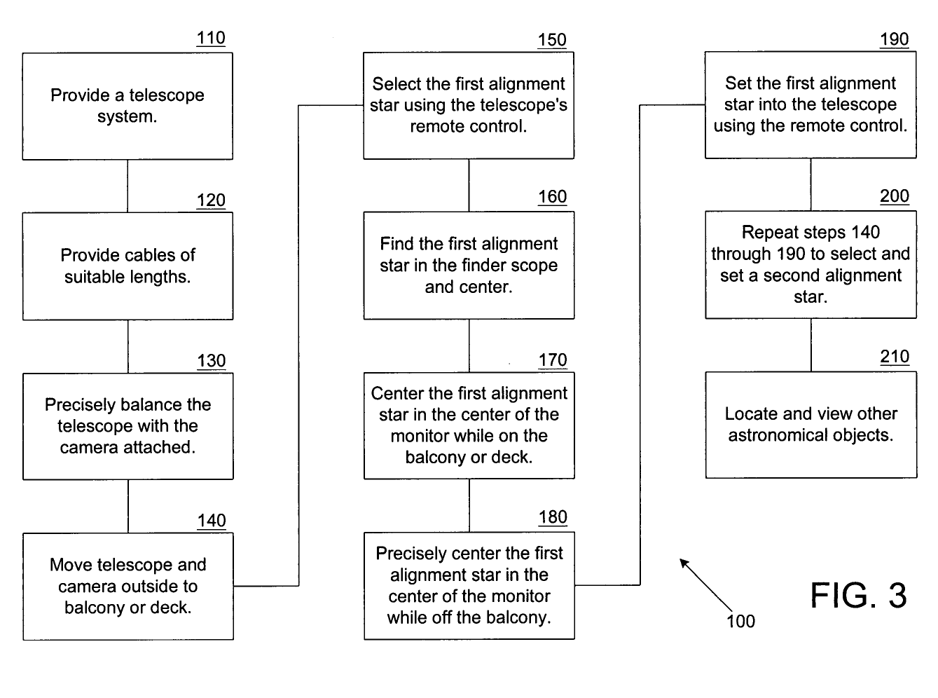

Referring now to FIG. 3, a method of precision viewing and tracking of astronomical objects with a telescope not located on solid ground. The method generally includes precisely balancing the telescope and performing an alignment of the telescope with the sky. The alignment of the telescope may be accomplished by a variety of alignment methods, such as a two star alignment, a GPS alignment, etc. The method described below in detail utilizes a two star alignment.

The method 100 includes step 110 of providing a computer controlled telescope with a video camera attached and a monitor. In step 120 cables of suitable lengths are provided to allow the connection of the camera to the monitor and a remote control to the telescope such that the telescope and camera may be located outside on a balcony or deck-like structure and the monitor and remote control may be located inside a house or apartment.

Step 130 provides for precisely balancing in both altitude and azimuth the telescope with the camera attached. This balancing means the center of gravity of the telescope will not change throughout it entire range of motion.

In step 140 the telescope and camera are moved outside onto a deck or balcony. The telescope and camera may be mounted on a rolling cart, a tripod, or any other sturdy device, or even on the surface of the deck. Some telescopes require that the telescope be pointed north with declination at 0° at the beginning of the alignment. After this step the alignment of the telescope with the sky begins.

Step 150 provides for selecting the first alignment star on the telescope using the telescope's remote control. The computer controlled telescope will then move the telescope such that the first alignment star is within the view of the finder scope.

Step 160 provides for the alignment of a first alignment star using a finder scope attached to the telescope while standing on the balcony or deck.

Step 170 provides for centering the first alignment star in the center of the monitor using the telescope controls while standing on the balcony. This step helps insure that the first alignment star will not move off the monitor when the user gets off the deck. At this point the first alignment star is still not set into the telescope because the balcony or deck will shift any time the user moves.

Step 180 provides for precisely centering the first alignment star in the center of the monitor using the remote control while not standing on the balcony. The monitor should include a set of cross hairs to facilitate this centering. The first alignment star is then set in the telescope in step 190.

Step 200 includes repeating steps 140 through 190 to select and set a second alignment star into the telescope.

Step 210 includes precisely locating astronomical objects using the remote control and viewing them on the monitor once the alignment is complete. At this point the user is located in his house or apartment and all activity on the deck or balcony is ceased.

Another potential feature of the telescope tracking system and method of the present invention would be a device to allow the telescope to be located and positioned exactly the same on the balcony or deck each time of use. This would allow the user to perform a single alignment and utilize a feature found in most telescopes regarding a permanent mounting of the telescope.

Many of the currently available telescopes also can be controlled with a personal computer. The monitor of the personal computer could also be used to display the video image from the telescope. The image could also be stored using one of the variety of storage devices of the personal computer.

The telescope tracking system and method of the present invention allows the study of astronomy off a balcony or deck-like structure in urban areas with considerable light pollution. This study could include the study of the sun, moon, planets, comets, and asteroids of our solar system for the beginning amateur astronomer or the study of deep space objects, such as star clusters, nebulae, and galaxies, for the more advanced amateur astronomer. This is something that experts in the field of astronomy say cannot be accomplished.

It should be emphasized that the above-described embodiments of the present invention, particularly, any “preferred” embodiments, are merely possible examples of implementations, merely set forth for a clear understanding of the principles of the invention. Many variations and modifications may be made to the above-described embodiment(s) of the invention without departing substantially from the spirit and principles of the invention. All such modifications and variations are intended to be included herein within the scope of this disclosure and the present invention and protected by the following claims.

Therefore, having thus described the invention, at least the following is claimed:

1. A telescope system comprising:
a portable computer controlled telescope;
a video imaging camera attached to the telescope; and
a monitor connected to the video imaging camera;
whereby the telescope with the video imaging camera attached is precisely balanced in both altitude and azimuth.

2. The system of claim 1, wherein the computer controlled telescope includes a remote control for controlling the movement of the telescope.

3. The system of claim 1, wherein the video imaging camera utilizes CCD technology.

4. The system of claim 1, wherein the video imaging camera accumulates and averages data for approximately 2 seconds prior to transmitting the data to the monitor.

5. The system of claim 1, wherein the monitor is a high resolution monitor.

6. The system of claim 1, wherein the monitor includes a screen having a set of cross hairs.

7. The system of claim 1, further comprising a recording device connected to the monitor.

8. The system of claim 7, further comprising a microphone connected to the recording device via a power mixer.

9. The system of claim 1, wherein the telescope is mounted on a rolling table.

10. A portable computer controlled telescope adapted to be precisely balanced in altitude and azimuth throughout entire range of motion of the telescope.

11. The telescope of claim 10 further including a video imaging camera attached thereto.

12. A method for viewing and tracking of astronomical objects using a telescope system, comprising the steps of:
providing a telescope system comprising a portable computer controlled telescope, a video imaging camera attached to the telescope, and a monitor;
precisely balancing the telescope with the camera attached in both altitude and azimuth for the telescope's entire range of motion;
placing the telescope and camera on a structure that allows movement of the structure in relation to the earth's surface; and
performing an alignment of the telescope.

13. The method of claim 12, wherein the alignment is a two star alignment.

14. The method of claim 12, wherein the alignment is a GPS alignment.

15. The method of claim 12, further comprising the step of centering a first alignment star in the center of the monitor while an operator is on the structure.

16. The method of claim 12, further comprising the step of precisely centering a first alignment star in the center of the monitor using a remote control of the telescope while an operator is not on the structure.

17. The method of claim 16, wherein the step of precisely centering includes centering the first alignment star using a set of cross hairs on the monitor.

18. The method of claim 12, wherein the structure is one of a balcony and a deck.

19. The method of claim 12, wherein the video imaging camera utilizes CCD technology.

20. The method of claim 12, wherein the monitor is a high resolution monitor.

21. A method for viewing and tracking of astronomical objects using a telescope system, comprising the steps of:
providing a telescope system comprising a portable computer controlled telescope, a video imaging camera attached to the telescope, and a monitor;
placing the telescope and camera on a structure that allows movement of the structure in relation to the earth's surface;
performing one part of an alignment of the telescope while an operator is on the structure; and
performing another part of the alignment of the telescope while the operator is off the structure.
